(19) United States
(12) Patent Application Publication
(10) Pub. No.: US 2006/0151483 A1
(43) Pub. Date: Jul. 13, 2006

(54) Oven

(76) Inventor: Min Ho Yun, Changwon-shi (KR)

Correspondence Address: FLESHNER & KIM, LLP, P.O. BOX 221200, CHANTILLY, VA, 20153, US

(21) Appl. No.: 11/328,463

(22) Filed: Jan. 10, 2006

(30) Foreign Application Priority Data
Jan. 12, 2005 (KR) 10-2005-0002755
Jan. 11, 2005 (KR) 20-2005-0000794
Apr. 27, 2005 (KR) 20-2005-0011691

(51) Int. Cl. H05B 6/64

(52) U.S. Cl. 219/685

(57) ABSTRACT

An oven is provided. The oven includes a block sealing a gap between a plate coupling portion and a coupling portion of a counterpart. The oven includes the plate coupling portion for coupling cavity plates to a front plate. The plate coupling portion has a shape formed by bending a front side of the cavity plates to cover the front plate. The oven includes a unit support and a unit fixing portion. The unit support is formed on cavity plates to support a chamber unit, and the unit fixing portion fixes the chamber unit to the cavity plates.

### BACKGROUND OF THE INVENTION

1. Field of the Invention

The present invention relates to an oven, and more particularly, to an oven assembly.

2. Description of the Related Art

An oven is a device that applies heat generated from a heater to food received in a cavity formed inside the oven to perform cooking. The cavity may be opened/closed using a door rotatably installed on the front side of the oven. The door includes a door frame constituting a frame of the door. A door panel is attached to the door frame. The door panel isolates the cavity from the outside.

The cavity is formed of a plurality of plates. The plates include an U-shaped plate constituting a lower surface and side surfaces in a U shape, a rear plate constituting a rear side, and an upper plate constituting an upper surface. The U-shaped plate and the upper plate are coupled to a front plate of the oven.

However, according to the related art oven, after the front plate is coupled to the U-shaped plate/upper plate, and the U-shaped plate is coupled to the upper plate, then they are fastened using bolts. At this point, a fine gap is generated between coupled surfaces, so that the cavity formed therein is not completely closed. Accordingly, heat in the inside of the cavity leaks out through the gap and heat loss is generated, which reduces the heat efficiency of the oven.

A heater chamber is provided to the lower portion of the related art oven, and a lower heater is installed in the heater chamber. The heater chamber is formed using an assembly including a plate. However, the assembly adopted to the related art oven is installed to a body of the oven using a plurality of bolts. Therefore, it is not easy to install/separate the lower heater to/from the oven.

Also, when the lower heater is broken down and should be repaired, separation of the assembly has not been easy due to the above-described installation structure. Therefore, the bottom surface constituting a portion of the cavity should be separated and an operator should access the lower heater through the cavity in order to repair the same. Therefore, accessibility for the lower heater is poor, which makes it difficult to perform repairing work for the lower heater.

### SUMMARY OF THE INVENTION

Accordingly, the present invention is directed to an oven assembly that substantially obviates one or more problems due to limitations and disadvantages of the related art.

An object of the present invention is to provide an oven for improving heat efficiency by preventing heat inside a cavity from leaking out through a gap generated in a coupling surface where plates constituting the cavity are coupled to a counterpart.

Another object of the present invention is to provide an oven capable of allowing a unit constituting a heater chamber where a lower heater is installed to be easily coupled and improving accessibility for repairing of the lower heater.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an oven including: cavity plates constituting a cavity; a plate coupling portion for coupling the cavity plates to a coupling portion of a predetermined counterpart; and a block sealing a gap between the plate coupling portion and the coupling portion of the counterpart.

In another aspect of the present invention, there is provided an oven including: cavity plates constituting a cavity; a front plate provided to a front side of the cavity; and a plate coupling portion for coupling the cavity plates to the front plate, wherein the plate coupling portion has a shape formed by bending a front portion of the cavity plate, and covers the front plate.

In a further another aspect of the present invention, there is provided an oven including: cavity plates constituting a cavity; a chamber unit constituting a chamber in which a heater is received; a unit support provided to the cavity plates, for supporting the chamber unit; and a unit fixing portion for fixing the chamber unit to the cavity plates.

According to the oven of the present invention, since a coupling surface where the plates constituting the cavity are coupled to a counterpart is covered with a block or a cover, a gap formed in the coupling surface is sealed. Therefore, heat leakage from the inside of the cavity through the gap is prevented, so that heat efficiency of the oven improves.

Also, according to the oven of the present invention, since one side of the chamber unit is fitted in the unit support and the other side of the chamber unit is fixed in the unit fixing portion, the chamber unit may be easily coupled/separated, and accessibility for a lower heater may be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of an oven according to a first embodiment of the present invention;

FIG. 2 is a side view of a cavity assembly adopted to an oven according to a first embodiment of the present invention;

FIG. 3 is a side view of a cavity assembly adopted to an oven according to a second embodiment of the present invention;

FIG. 4 is a side view of a cavity assembly adopted to an oven according to a third embodiment of the present invention;

FIG. 5 is a side view of a cavity assembly adopted to an oven according to a fourth embodiment of the present invention;

FIG. 6 is a perspective view of a cover according to a fourth embodiment of the present invention;

FIG. 7 is a side view of a cavity assembly adopted to an oven according to a fifth embodiment of the present invention;

FIG. 8 is a side view of a cavity assembly adopted to an oven according to a sixth embodiment of the present invention;

FIG. 9 is a perspective view of a cover according to a sixth embodiment of the present invention;

FIG. 10 is a front view of a cavity assembly adopted to an oven according to a seventh embodiment of the present invention;

FIG. 11 is a horizontal sectional view for a portion of a cavity assembly according to a seventh embodiment of the present invention;

FIG. 12 is a side view for a lower portion of a cavity assembly according to an eighth embodiment of the present invention;

FIG. 13 is a side view of a chamber unit according to an eight embodiment of the present invention;

FIG. 14 is a side view illustrating one side of a chamber unit is inserted into a unit support according to an eight embodiment of the present invention; and

FIG. 15 is a side view illustrating the other side of the chamber unit illustrated in FIG. 14 is fixed in a unit fixing portion.

### DETAILED DESCRIPTION OF THE INVENTION

Reference will now be made in detail to the preferred embodiments of the present invention, examples of which are illustrated in the accompanying drawings.

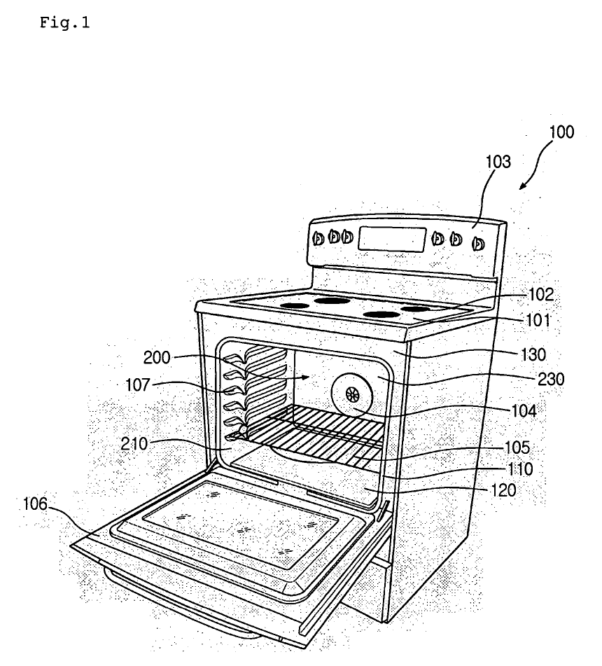

FIG. 1 is a perspective view of an oven according to a first embodiment of the present invention.

Referring to FIG. 1, the oven 100 includes a door 106 mounted on a front side, for being opened/closed, and a cavity 200 opened/closed by the door 106. The cavity 200 is a space for cooking food. The oven 100 further includes a convection heater and a fan 104 disposed on the backside of the cavity 200 to act on the cavity 200.

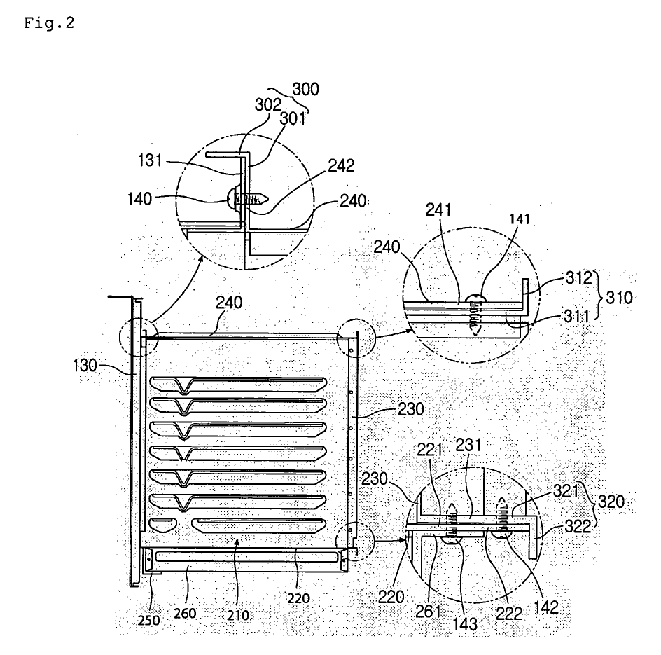

The cavity 200 is formed by side plates 210, a rear plate 230, a lower plate 220 (of FIG. 2), and an upper plate 240 (of FIG. 2). These plates will be described later.

The side plates 210 and the lower plate 220 are coupled to a front plate 130, which constitutes a front side of the oven 100. The front plate 130 is shielded by the door 106 when the door 106 is closed.

A sealing member 110 is installed in the front plate 130 along the outer edge of the cavity 200. The sealing member 110 blocks a gap between the door 106 and the front plate 130 when the door 106 is closed, so that the cavity 200 can be isolated from the outside.

Also, a lower heater (not shown) serving as a heat source when food is cooked, and a bottom 120 coupled to the upper portion of the lower heater are provided to the lower portion of the cavity 200. In detail, the bottom 120 prevents the lower heater from being exposed to the outside when food is cooked. Therefore, a danger that the lower heater is exposed and a user is injured is prevented.

FIG. 2 is a side view of a cavity assembly adopted to an oven according to a first embodiment of the present invention.

Referring to FIG. 2, the side plates 210, the lower plate 220, and the upper plate 240 are installed behind the front plate 130. The side plates 210, the lower plate 220, and the upper plate 240, and the rear plate 230 constitute the cavity 200. A chamber unit 260 is installed in a lower side of the lower plate 220.

The front plate 130 and the upper plate 240 are coupled to each other at the back of the front plate 130. In detail, coupling portions 131 and 300 are formed in the back of the front plate 130 and in the front of the upper plate 240, respectively. The coupling portion 131 of the front plate 130 has a shape formed by bending the end of the front plate 130 upward. The coupling portion 300 of the upper plate 240 includes a connection portion 301 having a shape formed by bending the front end of the upper plate 240 upward and a block 302 having a shape formed by bending the end of the connection portion 301 to the front.

A separate fixing member 140 such as a bolt passes through the coupling portion 131 of the front plate 130 and the connection portion 301 of the upper plate 240, so that the coupling portion 131 of the front plate 130 and the connection portion 301 of the upper plate 240 are coupled to each other. At this point, a fine gap may be generated between the coupling portion 131 and the connection portion 301. According to the present embodiment, when the coupling portion 131 is coupled to the connection portion 301, the block 302 covers each end of the coupling portion 131 and the connection portion 301. Therefore, the gap between the coupling portion 131 and the connection portion 301 can be blocked by the block 302. Accordingly, it is possible to prevent heat in the inside of the cavity 200 from leaking out to the outside through the gap.

The upper plate 240 and the rear plate 230 are coupled to each other at the back of the cavity 200. In detail, coupling portions 241 and 310 are formed in the rear side of the upper plate 240 and in the upper side of the rear plate 230, respectively. The coupling portion 310 of the rear plate 230 includes a connection portion 311 connected with the end of the rear plate 230 and a block 312 having a shape formed by bending the end of the connection portion 311 upward. A separate fixing member 141 such as a bolt passes through the coupling portion 241 of the upper plate 240 and the connection portion 311 of the rear plate 230, so that the coupling portion 241 of the upper plate 240 and the connection portion 311 of the rear plate 230 are coupled to each other. At this point, a fine gap may be generated between the coupling portion 241 and the connection portion 311. According to the present embodiment, when the coupling portion 241 is coupled to the connection portion 311, the block 312 covers each end of the coupling portion 241 and the connection portion 311. Therefore, the gap between the coupling portion 241 and the connection portion 311 can be blocked by the block 312. Accordingly, it is possible to prevent heat in the inside of the cavity 200 from leaking out to the outside through the gap.

The rear plate 230 and the lower plate 220 are coupled to each other at the lower side of the cavity 200. In detail, coupling portions 320 and 222 are formed in the lower side of the rear plate 230 and in the rear side of the lower plate 220, respectively. The coupling portion 320 of the rear plate 230 includes a connection portion 321 connected with the end of the rear plate 230 and a block 322 having a shape formed by bending the end of the connection portion 321 upward. An upper unit fixing portion 231 is formed between the rear plate 230 and the connection portion 321. A lower unit fixing portion 221 is formed between the lower plate 220 and the coupling portion 222.

A separate fixing member 143 passes through the upper unit fixing portion 231 and the lower unit fixing portion 221. These unit fixing portions 231 and 221 will be described later.

A separate fixing member 142 passes through the connection portion 321 of the rear plate 230 and the coupling portion 222 of the lower plate 220, so that the coupling portion 321 of the rear plate 230 and the coupling portion 222 of the lower plate 220 are coupled to each other. At this point, a fine gap may be generated between the connection portion 321 and the coupling portion 222. According to the present embodiment, when the connection portion 321 is coupled to the coupling portion 222, the block 322 covers each end of the connection portion 321 and the coupling portion 222. Therefore, the gap between the coupling portion 222 and the connection portion 321 can be blocked by the block 322. Accordingly, it is possible to prevent heat in the inside of the cavity 200 from leaking out to the outside through the gap.

Here, to make manufacturing easy, the connection portion 301/the block 302 may be integrally formed with the upper plate 240, and the connection portion 311/the block 312 and the connection portion 321/the block 322 may be integrally formed with the upper portion and the lower portion of the rear plate 230, respectively.

Though the blocks 302, 312, and 322 are illustrated as being formed on the front side of the upper plate 240, the upper portion, and the lower portion of the rear plate 230, respectively, the blocks 302, 312, and 322 may also be formed on the front plate 130, the rear side of the upper plate 240, and the lower plate 220.

Other embodiments of the present invention will be described below with reference to the accompanying drawings. In describing the embodiments, the same parts as those of the first embodiment will be omitted.

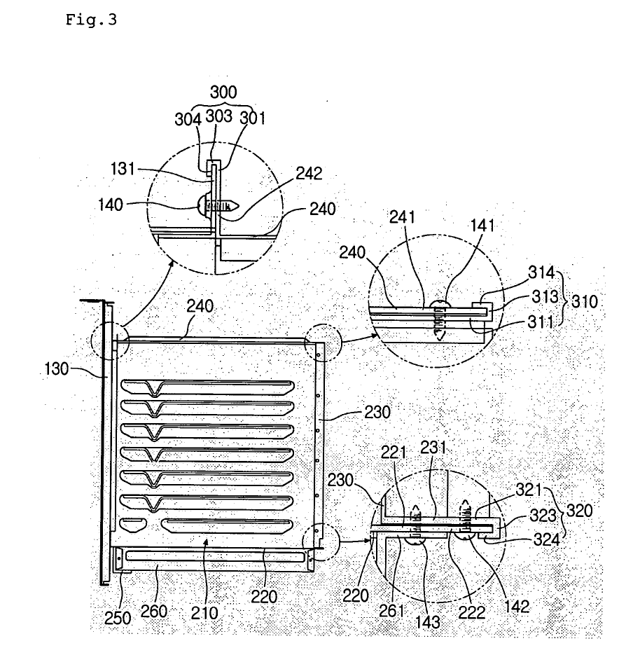

FIG. 3 is a side view of a cavity assembly adopted to an oven according to a second embodiment of the present invention.

Referring to FIG. 3, a coupling portion 300 of the upper plate 240 includes a connection portion 301, a horizontal block 303 having a shape bent from the connection portion 301 to a front side, and a vertical block 304 having a shape bent from the horizontal block 303 to a lower side. Each of The horizontal block 303 and the vertical block 304 may be defined as blocks. The connection portion 301, the horizontal block 303, and the vertical block 304 encloses the coupling portion 131 of the front plate 130. Accordingly, a gap between the coupling portion 131 and the connection portion 301 of the front plate 130 may be doubly blocked by the horizontal block 303 and the vertical block 304. Therefore, it is possible to more reliably prevent heat in the inside of the cavity 200 from leaking out to the outside through the gap.

The coupling portions 310 and 320 of the rear plate 230 include vertical blocks 313 and 323 having shapes bent from the connection portions 311 and 321 to an upper side and a lower side, respectively, and horizontal blocks 314 and 324 having shapes bent from the vertical blocks 313 and 323 to a front side, respectively. Accordingly, a gap between the coupling portion 241 and the connection portion 311 of the upper plate 240, and a gap between the coupling portion 222 and the connection portion 321 of the lower plate 220 may be doubly blocked by the blocks. Therefore, it is possible to more reliably prevent heat in the inside of the cavity 200 from leaking out to the outside through the gap.

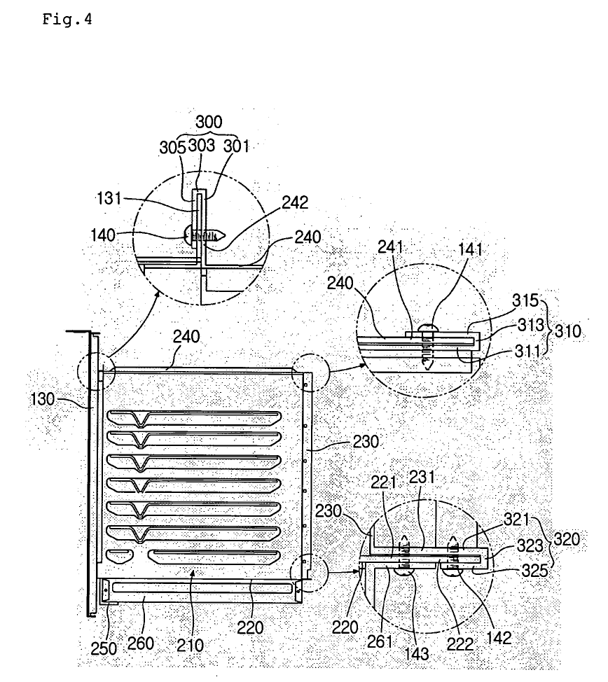

FIG. 4 is a side view of a cavity assembly adopted to an oven according to a third embodiment of the present invention.

Referring to FIG. 4, a horizontal block 303 has a shape bent from a connection portion 301 of the upper plate 240 to a front side and a vertical block 305 has a shape bent from the horizontal block 303 to a lower side. A fixing member 140 passes through the vertical block 305, the coupling portion 131 of the front plate 130, and the connection portion 301. Accordingly, a gap between the vertical block 305, the coupling portion 131, and the connection portion 301 may be minimized by coupling force of the fixing member 140. Therefore, it is possible to more reliably prevent heat in the inside of the cavity 200 from leaking out to the outside through the gap.

The coupling portions 310 and 320 of the rear plate 230 include vertical blocks 313 and 323 having shapes bent from the connection portions 311 and 321 to an upper side and a lower side, respectively, and horizontal blocks 315 and 325 having shapes bent from the vertical blocks 313 and 323 to a front side, respectively. A fixing member 141 passes through the horizontal block 315, the coupling portion 241 of the upper plate, and the connection portion 311. A fixing member 142 passes through the horizontal block 325, the coupling portion 222 of the lower plate 220, and the connection portion 321. Therefore, a gap between the coupling portion 241 of the upper plate 240 and the concoction portion 311, and a gap between the coupling portion 222 of the lower plate 220 and the connection portion 321 may be minimized by coupling force of the fixing members 141 and 142. Therefore, it is possible to more reliably prevent heat in the inside of the cavity 200 from leaking out to the outside through the gap.

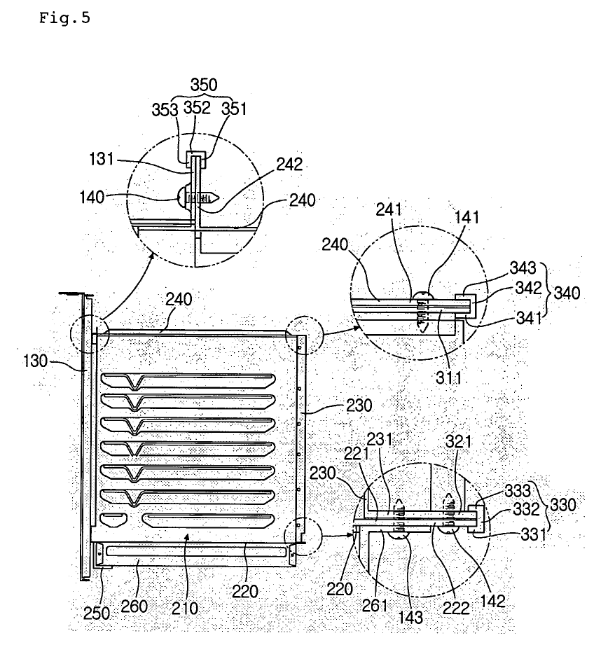

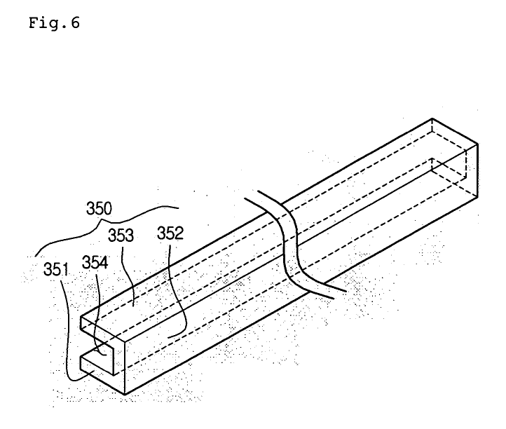

FIG. 5 is a side view of a cavity assembly adopted to an oven according to a fourth embodiment of the present invention, and FIG. 6 is a perspective view of a cover according to a fourth embodiment of the present invention.

Referring to FIGS. 5 and 6, a fixing member 146 passes through a coupling portion 131 of a front plate 130 and a coupling portion 242 of an upper plate 240, thereby coupling them. A cover 350 covers the ends of the coupling portions 131 and 242.

Referring to FIG. 6, the cover 350 includes a front leg portion 353, a rear leg portion 351, and a connection portion for connecting the front leg portion 353 with the rear leg portion 351. A groove 354 is formed in the inside of the cover 350, and the coupling portions 131 and 242 are fitted in the groove 354.

The cover 350 covers the gap between the coupling portions 131 and 242 in a length direction of the cover 350. Therefore, since the gap is blocked by the cover 350, heat leakage of a cavity 200 through the gap may be prevented.

Here, the coupling portions 131 and 242 may be fitted in the groove 354 of the cover 350. With such a structure, the front leg portion 353 and the rear leg portion 351 press the coupling portions 131 and 242, so that a gap between the coupling portions 131 and 242 may be reduced.

Also, a cover 340 covers a coupling portion 241 in a rear side of an upper plate 240, a coupling portion 311 in an upper side of a rear plate 230. The cover 340 includes an upper leg portion 343, a lower leg portion 341, and a connection portion 342. Of course, the coupling portions 241 and 311 are fitted in the cover 340.

Also, a cover 330 covers a coupling portion 321 in a lower side of the rear plate 230 and a coupling portion 222 of a lower plate 220. The cover 330 includes an upper leg portion 333, a lower leg portion 331, and a connection portion 332. Of course, the coupling portions 321 and 222 are fitted in the cover 330.

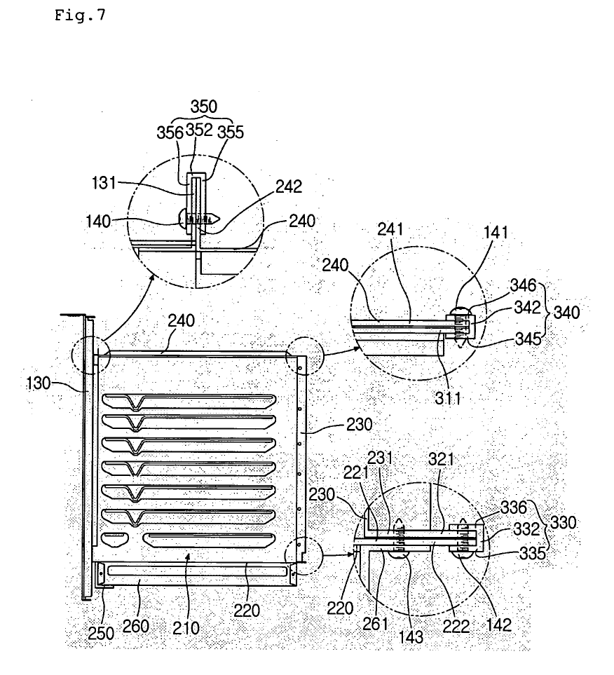

FIG. 7 is a side view of a cavity assembly adopted to an oven according to a fifth embodiment of the present invention.

Referring to FIG. 7, a coupling portion 131 of a front plate 130 and a coupling portion 242 at a front side of an upper plate 240 are covered with a cover 350. The cover 350 includes a front leg portion 356, a rear leg portion 355, and a connection portion 352.

A fixing member 140 passes through the front leg portion 356, the rear leg portion 355, and the coupling portions 131 and 242, thereby fixing them together. With such a structure, since the front leg portion 356 and the rear leg portion 355 press the coupling portions 131 and 242, a gap between the coupling portions 131 and 242 may be reduced even more. Therefore, it is possible to more reduce heat loss due to heat leakage through a gap between the coupling portions 131 and 242 and increase coupling reliability of the cover 350.

Also, a cover 340 covers a coupling portion 241 in a rear side of an upper plate 240, a coupling portion 311 in an upper side of a rear plate 230. The cover 340 includes an upper leg portion 346, a lower leg portion 345, and a connection portion 342. Of course, a fixing member 141 passes through the upper leg portion 346, the coupling portions 241 and 311, and the lower leg portion 345, thereby fixing them together.

Also, a cover 330 covers a coupling portion 321 in a lower side of the rear plate 230 and a coupling portion 222 of a lower plate 220. The cover 330 includes an upper leg portion 336, a lower leg portion 335, and a connection portion 332. Of course, a fixing member 142 passes through the upper leg portion 336, the coupling portions 321 and 222, and the lower leg portion 335, thereby fixing them together.

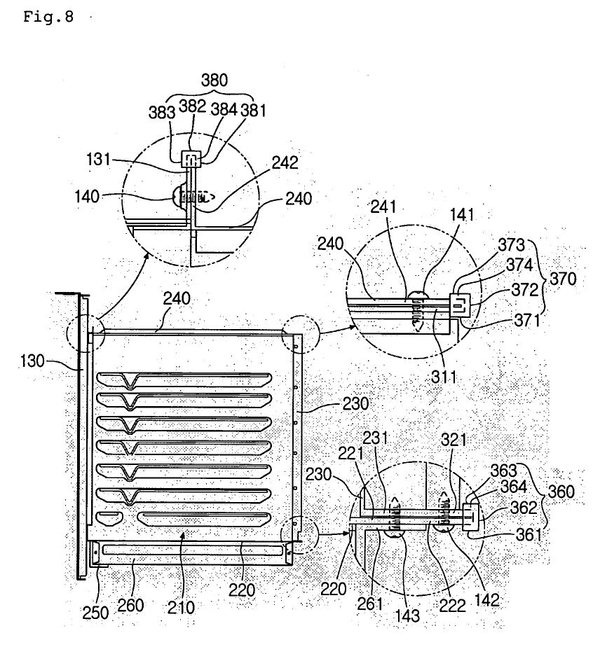

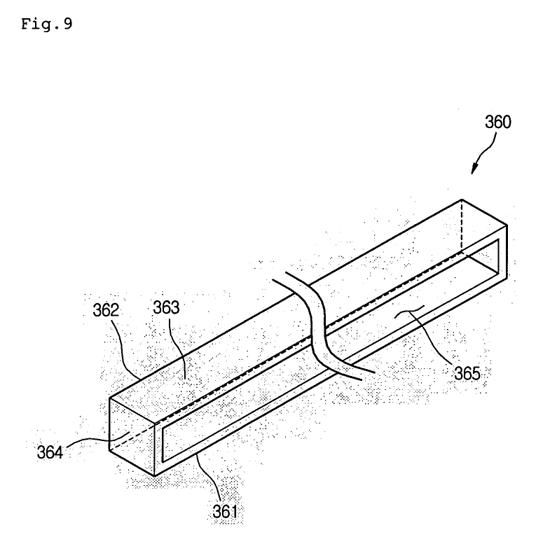

FIG. 8 is a side view of a cavity assembly adopted to an oven according to a sixth embodiment of the present invention, and FIG. 9 is a perspective view of a cover according to a sixth embodiment of the present invention.

Referring to FIGS. 8 and 9, a coupling portion 321 in a lower side of a rear plate 230 and a coupling portion 222 of a lower plate 220 are covered with a cover 360.

Referring to FIG. 9, the cover 360 includes an upper leg portion 363, a lower leg portion 361, a side leg portion 364, and a connection portion for connecting the upper leg portion 363, the lower leg portion 361, and the side leg portion 364. A groove 365 is formed in the inside of the cover 360, and the coupling portions 321 and 222 are fitted in the groove 365.

The cover 360 covers a gap between the coupling portions 321 and 222 in a length direction and a thickness direction of the cover 360. Therefore, since the four sides of the gap are blocked by the cover 360, heat leakage from a cavity 200 through the gap may be prevented.

Here, the coupling portions 321 and 222 may be fitted in the groove 365 of the cover 360. With such a structure, the upper leg portion 363, the lower leg portion 361, and the side leg portion press the coupling portions 321 and 222, so that a gap between the coupling portions 321 and 222 may be reduced.

Also, a cover 370 covers a coupling portion 241 in a rear side of the upper plate 240, a coupling portion 311 in an upper side of the rear plate 230. The cover 370 includes an upper leg portion 373, a lower leg portion 371, a side leg portion 374, and a connection portion 372. Of course, the coupling portions 241 and 311 are fitted in the cover 370.

Also, a cover 380 covers a coupling portion 131 of a front plate 130 and a coupling portion 242 of an upper plate 240. The cover 380 includes a front leg portion 383, a rear leg portion 381, a side leg portion 384, and a connection portion 382. Of course, the coupling portions 131 and 242 are fitted in the cover 380.

Here, leg portions of the covers 360, 370, and 380 is extended, so that fixing members 142, 141, and 140 may pass through the leg portions and the coupling portions. With such a structure, coupling force of the covers 360, 370, and 380 increases, so that reliability of coupling increases and a gap between the coupling portions may be reduced even more.

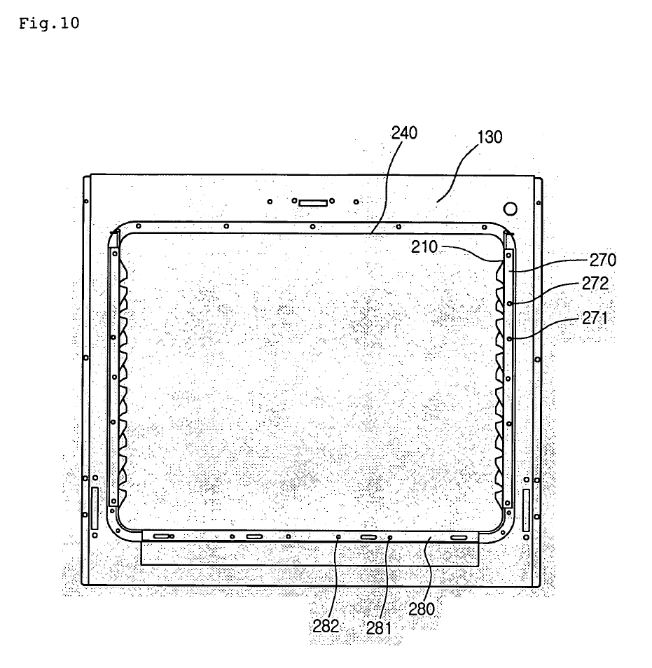

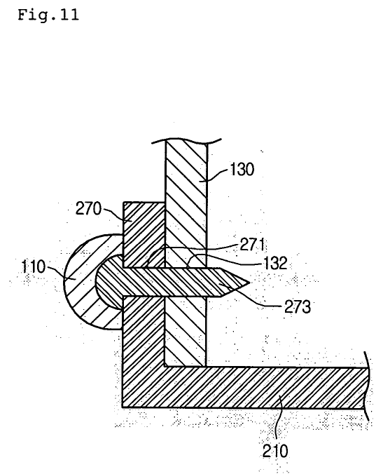

FIG. 10 is a front view of a cavity assembly adopted to an oven according to a seventh embodiment of the present invention, and FIG. 11 is a horizontal sectional view for a portion of a cavity assembly according to a seventh embodiment of the present invention.

Referring to FIGS. 10 and 11, a cavity 200 is formed in the inside of a front plate 130. The cavity 200 includes side plates 210, a lower plate 220, and an upper plate 240 coupled to the front plate 130, and a rear plate 230.

According to the present embodiment, a side plate coupling portion 270 is provided to a front side of the side plates 210, and a lower plate coupling portion 280 is provided to a front side of the lower plate 220. The side plate coupling portion 270 and the lower plate coupling portion 280 have shapes formed by bending a front side of the side plate 210 and a front side of the lower plate 220, respectively. Plate coupling holes 271 and 281 are formed in the side plate coupling portion 270 and the lower plate coupling portion 280, respectively. A separate fixing member 132 passes through the plate coupling holes 271 and 281 from front sides of the side plate coupling portion 270 and the lower plate coupling portion 280, and also passes through predetermined holes formed in the front plate 130. Accordingly, the side plate coupling portion 270 and the lower plate coupling portion 280 are installed on the front side of the front plate 130. The side plate 210 and the lower plate 220 may be installed on the front plate 130 through the side plate coupling portion 270 and the lower plate coupling portion 280. The upper plate 240 may be installed on the front plate 130 by coupling to the side plates 210 and the lower plate 220.

When the plates 210, 220, and 240 are installed in the front plate 130, separate coupling portions for coupling to the front plate 130 do not need to be provided to the inside of the plates 210, 220, and 240. Therefore, since the inner surfaces of the plates 210, 220, and 240 can be integrally formed, a gap that has been generated due to coupling of the plates 210, 220, and 240 to the front plate 130 is not generated. Accordingly, since heat leakage from the inside of the cavity 200 through the gap may be prevented, heat efficiency of the oven 100 may be enhanced.

Here, though the side plate coupling portion 270 and the lower plate coupling portion 280 are provided according to the present invention, these coupling portions are provided for an exemplary purpose only. That is, an upper plate coupling portion may be further provided besides the plate coupling portions 270 and 280.

Sealing member coupling holes 272 and 282 to which sealing members 110 are coupled are formed in the side plate coupling portion 270 and the lower plate coupling portion 280. The sealing member coupling holes 272 and 282 are formed in the side plate coupling portion 270 and the lower plate coupling portion 280, so that each of the sealing members 110 cover each of the fixing members 132. Therefore, the sealing member 110 serves as a buffering member for preventing a direct collision between the fixing member 132 and a door 106. Therefore, when the door 106 is closed, the door 106 may not be transformed/destroyed due to collision with the fixing member 132. Also, since the fixing member 132 is not exposed to the outside, a beautiful appearance may be obtained.

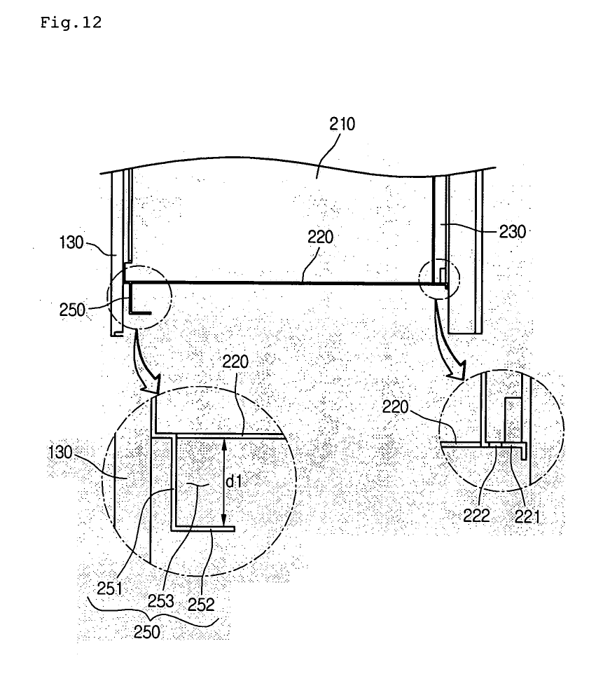

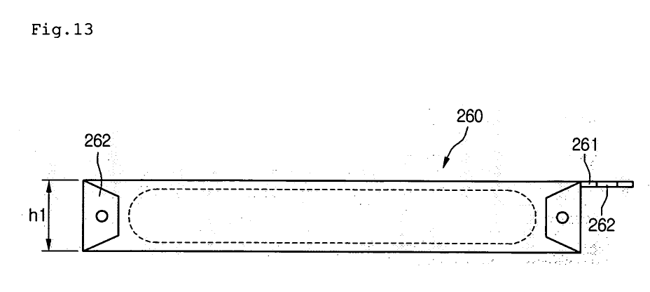

FIG. 12 is a side view for a lower portion of a cavity assembly according to an eighth embodiment of the present invention, and FIG. 13 is a side view of a chamber unit according to an eight embodiment of the present invention.

Referring to FIGS. 12 and 13, the chamber unit 260 has an inside in which a lower heater is installed. The chamber unit 260 has a predetermined height h1. A unit coupling portion 262 is provided to a rear side of the chamber unit 260. A hole through which a fixing member passes is formed in the unit coupling portion 262.

A unit support 250 is formed in a front side of the lower plate 220. The unit support 250 is a part into which a front side of the chamber unit 260 is inserted. A lower unit fixing portion 221 is provided in a rear side of the lower plate 220. An upper unit fixing portion 231 that corresponds to the lower unit fixing portion 221 is provided in a lower side of the rear plate 230.

The unit support 250 includes a unit connection portion 251 and a unit seating portion 252. The unit connection portion 251 is a portion connected with the lower plate 220. The unit connection portion 251 may be formed integrally with the lower plate 220 or separately manufactured and then coupled. The unit seating portion 252 has a shape bent from the end of the unit connection portion 251 to a rear side. A space defined by the unit connection portion 251 and the unit seating portion 252 is a unit seating hole 253. A front side of the chamber unit 260 is seated in the unit seating hole 253. The unit seating portion 252 is spaced a predetermined distance d1 from the lower plate 220. The distance d1 may be almost the same as the height h1 of the chamber unit 260, so that the front side of the chamber unit 260 is fitted in the unit support 250 and that chamber unit 260 may be stably coupled.

A fixing member passes through holes formed in the upper unit fixing portion 231, the lower unit fixing portion 221, and the unit coupling portion 262, so that a rear side of the chamber unit 260 may be fixed on the lower plate 220.

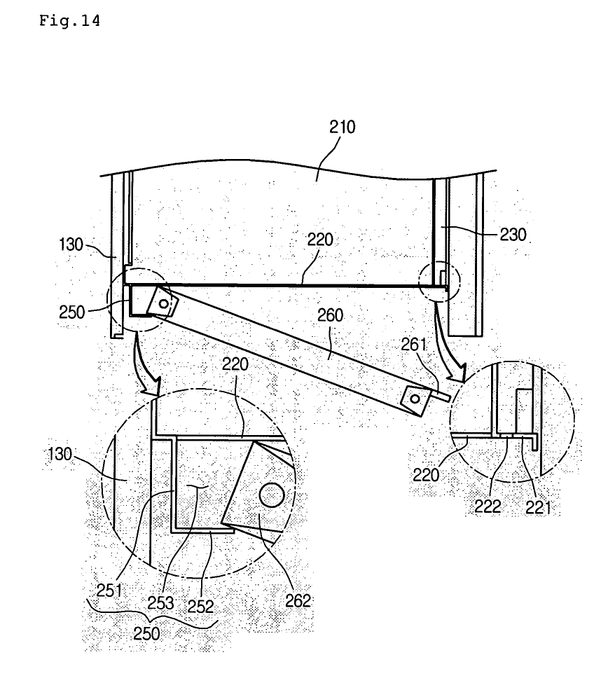

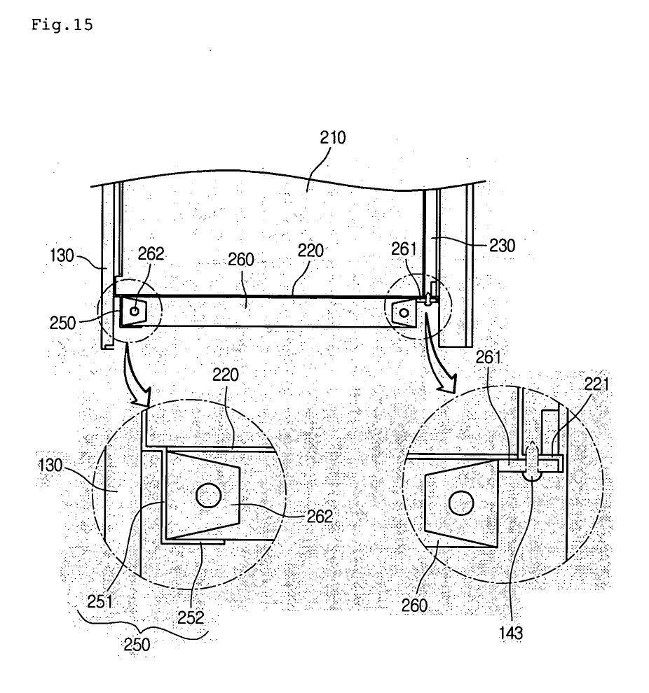

FIGS. 14 and 15 are views a process of coupling a chamber unit according to an eight embodiment of the present invention.

FIG. 14 is a side view illustrating one side of a chamber unit is inserted into a unit support according to an eight embodiment of the present invention, and FIG. 15 is a side view illustrating the other side of the chamber unit illustrated in FIG. 14 is fixed in a unit fixing portion.

The process of coupling the chamber unit according to the present invention will be described with reference to FIGS. 14 and 15.

Referring to FIG. 14, the front side of the chamber unit 260 is loaded on the unit seating portion 252 of the unit support 250.

After that, the chamber unit 260 is rotated toward the lower plate 220 using a contact surface between the front side of the chamber unit 260 and the unit seating portion 252 for a rotational axis. Then, referring to FIG. 15, the unit coupling portion 261 of the chamber unit 260 contacts the lower unit fixing portion 221, and the front side of the chamber unit 260 is fitted in the unit seating hole 253.

With such a state, a fixing member 143 sequentially passes through a hole 262 of the unit coupling portion 261, a hole 222 of the lower unit fixing portion 221, and a hole of the upper unit fixing portion 231, so that a rear side of the chamber unit 260 is fixed on the lower plate 220. At this point, since the front side of the chamber unit 260 is fitted in the unit seating hole 253, the chamber unit 260 is supported by the unit support 250.

When the fixing member 143 is removed and the chamber unit 260 is pulled to the rear side, the chamber unit 260 may be easily detached from the unit support 250. Therefore, since separation of the chamber unit 260 is easily performed, accessibility for the lower heater may be improved when the lower heater is broken down and should be separated.

According to the oven of the present invention, a block or a cover covers a coupling surface where the plates constituting the cavity are coupled to the counterpart, thereby blocking the gap generated in the coupling surface. Therefore, heat leakage from the inside of the cavity through the gap is prevented, so that heat efficiency of the oven may be improved.

Also, according to the present invention, since one side of the chamber unit is fitted in the unit support and the other side of the chamber unit is fixed in the unit fixing portion, coupling and separating of the chamber unit may be easily performed and the accessibility for the lower heater may be improved.

What is claimed is:

1. An oven comprising:
cavity plates constituting a cavity;
a plate coupling portion for coupling the cavity plates to a coupling portion of a predetermined counterpart; and
a block sealing a gap between the plate coupling portion and the coupling portion of the counterpart.

2. The oven according to claim 1, wherein the block is formed by bending one of the plate coupling portion and the coupling portion of the counterpart.

3. The oven according to claim 2, wherein the block is coupled to the plate coupling portion and the coupling portion of the counterpart.

4. The oven according to claim 3, wherein a fixing member passes through the block, the plate coupling portion, and the coupling portion of the counterpart.

5. The oven according to claim 1, wherein the block is a cover covering the plate coupling portion and the coupling portion of the counterpart.

6. The oven according to claim 5, wherein the plate coupling portion and the coupling portion of the counterpart are forcibly fitted in the cover.

7. The oven according to claim 5, wherein the cover is coupled to the plate coupling portion and the coupling portion of the counterpart.

8. The oven according to claim 7, wherein a fixing member passes through the cover, the plate coupling portion, and the coupling portion of the counterpart.

9. An oven comprising:
cavity plates constituting a cavity;
a front plate provided to a front side of the cavity; and
a plate coupling portion for coupling the cavity plates to the front plate,
wherein the plate coupling portion has a shape formed by bending a front portion of the cavity plate to cover the front plate.

10. The oven according to claim 9, wherein a sealing member is installed in the plate coupling portion.

11. The oven according to claim 10, wherein a fixing member passes through the plate coupling portion and a coupling portion of the front plate, and the sealing member covers the fixing member.

12. The oven according to claim 10, wherein the sealing member has a coupling pin, and the plate coupling portion has a hole into which the coupling pin is inserted.

13. The oven according to claim 9, wherein the plate coupling portion is formed on at least two sides of the cavity.

14. An oven comprising:
cavity plates constituting a cavity;
a chamber unit constituting a chamber in which a heater is received;
a unit support provided to the cavity plates, for supporting the chamber unit; and
a unit fixing portion for fixing the chamber unit to the cavity plates.

15. The oven according to claim 14, wherein the unit support comprises a connection portion connected with the cavity plates and a support having a shape bent from the connection portion.

16. The oven according to claim 14, wherein the unit support is integrally formed with the cavity plates.

17. The oven according to claim 14, wherein the unit support and the unit fixing portion are formed at both sides of the chamber unit, respectively.

18. The oven according to claim 14, wherein the chamber unit is forcibly fitted in the unit support.

19. The oven according to claim 18, wherein a thickness of a portion of the chamber unit fitted in the unit support is substantially the same as the size of a hole formed in the unit support.

20. The oven according to claim 14, wherein a fixing member passes through the unit fixing portion and a coupling portion of the chamber unit.
